(19) United States
(12) Patent Application Publication
(10) Pub. No.: US 2019/0154823 A1
(43) Pub. Date: May 23, 2019

(54) METHOD FOR DETECTING PEDESTRIANS USING 24 GIGAHERTZ RADAR

(71) Applicant: Valeo Radar Systems, Inc., Hudson, NH (US)

(72) Inventors: David Insana, Manchester, NH (US); Andrew Laffin, Wakefield, MA (US)

(73) Assignee: Valeo Radar Systems, Inc., Hudson, NH (US)

(21) Appl. No.: 15/816,306

(22) Filed: Nov. 17, 2017

(51) Int. Cl. G01S 13/04; G01S 13/89; G01S 13/93; G01S 7/03

(52) U.S. Cl. CPC G01S 13/04; G01S 13/89; G01S 2013/9378; G01S 7/03; G01S 2013/9389; G01S 13/931

(57) ABSTRACT

A method, system and technique is described for providing object detection. A plurality of detections for an area around at least a portion of a vehicle are acquired from at least one radar sensor. At least some of the plurality of detections are integrated to generate at least one image mask. The at least one image mask is applied to a host-compensated image of the area around at least a portion of the vehicle to determine a presence of static objects within the image.

### BACKGROUND

As is known in the art, radar sensors are increasingly being used within automobiles and other vehicles to provide information to drivers about the presence of people and vehicles in a vicinity of the automobiles. Radar sensors may be programmed to perform functions such as blind spot detection (BSD), lane change assist (LCA), cross traffic alert (CTA), rear detection, and others to enhance safety and driver awareness on the road.

Known methods for rear pedestrian detection (RPD) require a moving pedestrian in order to be able to detect and classify an object as pedestrian. These known methods do not work for detecting pedestrians which are not moving. This is caused by the low and diffuse radar cross section (RCS) and due to the fact that a static object does not have a velocity distribution. It is very challenging to distinguish between infrastructure and a static pedestrian due to co-range and co-Doppler distortion. There are a lot of scenarios in which it is very important to detect pedestrians which are not moving. This applies for example for parking maneuvers.

In non-RPD scenarios detections are desired in a further range (e.g., greater than twenty meters) and with a generally fast moving target. There is also typically good target to infrastructure Doppler separation. Uncertainty in these scenarios is usually related to noise and phase curve effects which hinder assigning azimuth correctly to these detections.

In RPD scenarios, the challenges are different. The vehicle is typically moving very slowly, is at close range (less than or equal to 15 meters, though farther is possible), is detecting static or very slow moving targets (below 10 kph). Uncertainty is affected by co-range, co-doppler and scintillation resulting from specular and multifaceted reflectors (parked cars, large plate target in field of view, etc.). These effects are rarely observed simultaneously by multiple sensors. For example, if there is a vehicle behind you, the left sensor will detect it in one location (rear bumper) while the right sensor might detect the fender of the same vehicle. The detection coordinates will be different but for the same target.

RPD also suffers from multipath effects. These effects are dependent on the layout of the scenario and occur more often for complicated scenarios. In an environment where there is a single person in an open field behind you, this is not much of an issue however for more complicated issues such as multiple targets in a crowded parking lot, multipath effects become an issue. Fading, which is due to multiple wavefronts received at slightly different times due to ground bounce, has the effect of distorting the magnitude, range and azimuth information of target. This increases the 2D spatial uncertainty factor for any given detection. This effect is influenced by the physical height of the sensor above the ground. Due to all the above described factors, a technique is needed which can resolve static or slow moving RPD targets.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Note that each of the different features, techniques, configurations, etc. discussed in this disclosure can be executed independently or in combination. Accordingly, embodiments of the concepts described herein can be embodied and viewed in many different ways. For additional details, elements, and/or possible perspectives (permutations) of the concepts described herein, the reader is directed to the Detailed Description section and corresponding figures of the present disclosure as further discussed below.

In accordance with the concepts, systems and techniques described herein, it has been appreciated that existing techniques for detecting rear objects (including, but not limited to pedestrians) provide poor performance. Accordingly, there is a need for an improved rear object detection technique which is capable of detecting objects (including, but not limited to pedestrians) having a low and/or diffuse radar cross section (RCS).

It has been found that the concepts, systems, devices and techniques described herein may be used in both a rear-looking object detection system (i.e. to detect one or more objects behind a rear of a vehicle when a vehicle is still or is backing up) as well as in a forward-looking object detection system (i.e. to detect one or more objects in front of a vehicle when a vehicle is moving forward). Vehicles may include either or both of such forward and/or rear object detection systems. Furthermore, such forward and/or rear object detection systems may find use in autonomous driving systems.

In accordance with a first aspect of the concepts, systems, devices and methods described herein, an object detection method for detecting objects (including, but not limited to pedestrians) in a front or rear of a vehicle includes acquiring a plurality of detections for an area around at least a portion of a vehicle from at least one radar sensor. The method further includes integrating at least some of the plurality of detections to generate at least one image mask. Additionally, the method requires applying the at least one image mask to a host-compensated image of the area around at least a portion of the vehicle to determine a presence of static or substantially static objects within the image. The objects may, for example, be pedestrians. The objects may be static (i.e. non-moving) or substantially static (slowly moving relative to the speed of the vehicle in which the front and/or rear object detection system is disposed. The concepts, systems, devices and methods described herein may also be applied to pedestrian detection or object detection at low speed in general.

Such a technique is useful for detecting objects (including, but not limited to pedestrians) having a low and/or diffuse radar cross section (RCS).

In embodiments, prior to the integrating at least some of the plurality of detections to generate at least one image mask, at least some detections from the sensors may be combined when there are more than one sensor. In embodiments, the mask may be a two-dimensional mask. In embodiments the two dimensions may comprise range and azimuth. In embodiments the detections may be weighted by the image mask prior to updating the host-compensated image.

In embodiments the method may further include calculating a confidence factor from a range confidence factor and an azimuth confidence factor. In some embodiments a range confidence factor may be calculated from a number of counts comprising a distance between a peak value and an average value divided by a distance between smoothed data cross over points with average in a range histogram. In embodiments an azimuth confidence factor may be calculated from a number of counts comprising a distance between a peak value and an average value divided by range, the range determined in accordance with the formula: a number of degrees between smoothed data cross over points with average multiplied by (Pi divided by 180) multiplied by a propagated range in an azimuth histogram. In embodiments detections that may be associated with multiple different sensors may be weighted higher.

Other arrangements of embodiments of the concepts described herein that are disclosed herein may include software programs to perform methods and operations summarized above and disclosed in detail below. More particularly, a computer program product is one embodiment may have a computer-readable medium including computer program logic encoded thereon that when performed in a computerized device provides associated operations providing pedestrian detection as explained herein. The computer program logic, when executed on at least one processor with a computing system, causes the processor to perform the operations (e.g., the methods) indicated herein as embodiments of the broad concepts described. Such arrangements/embodiments are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations may be installed onto a computerized device to cause one or more processors in the computerized device to perform the techniques explained herein as embodiments of the described concepts. Software processes that operate in a collection of computerized devices, such as in a group of data communications devices or other entities can also provide the system which implements the described concepts. The system(s), device(s) and technique(s) described herein can be distributed between many software processes on several data communications devices, or all processes could run on a small set of dedicated computers, or on one computer alone to implement the described concepts.

Details relating to this and other embodiments are described more fully herein.

### BRIEF DESCRIPTION OF THE DRAWING FIGS

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is a diagram showing a two-sensor field of view for a vehicle radar system in accordance with one illustrative embodiment;

FIG. 2 is a diagram illustrating an example radar minimum range, in accordance with illustrative embodiments;

FIG. 3 is a block diagram showing left and right radar sensors, in accordance with illustrative embodiments;

FIG. 4 is a flow diagram of an example of a rear or front object (e.g. pedestrian) detection digital signal processing functional flow, in accordance with illustrative embodiments;

FIG. 5 is a diagram showing pedestrian detections in accordance with illustrative embodiments;

FIG. 6 is a graph showing detections for a left sensor in accordance with illustrative embodiments;

FIG. 7 is a set of graphs showing a range histogram and an azimuth histogram for different left sensor groups in accordance with illustrative embodiments;

FIGS. 8A to 8C shows group masks generated from histograms in accordance with illustrative embodiments;

FIGS. 9A to 9B are a set of graphs for determining various confidence factors in accordance with illustrative embodiments;

FIG. 10 is an image showing group correlation and spatial uncertainty in accordance with illustrative embodiments;

FIG. 11 is an image showing reported radar objects in accordance with illustrative embodiments;

FIG. 12 is an image showing mask weighting in place detections in accordance with illustrative embodiments;

FIGS. 13A to 13B are a flow chart of an illustrative process providing front and/or rear object detection (including, but not limited to pedestrian detection) in accordance with illustrative embodiments; and

FIG. 14 is a block diagram of an example of a hardware device that may perform at least a portion of the process depicted in the flow chart of FIGS. 13A to 13B.

### DETAILED DESCRIPTION

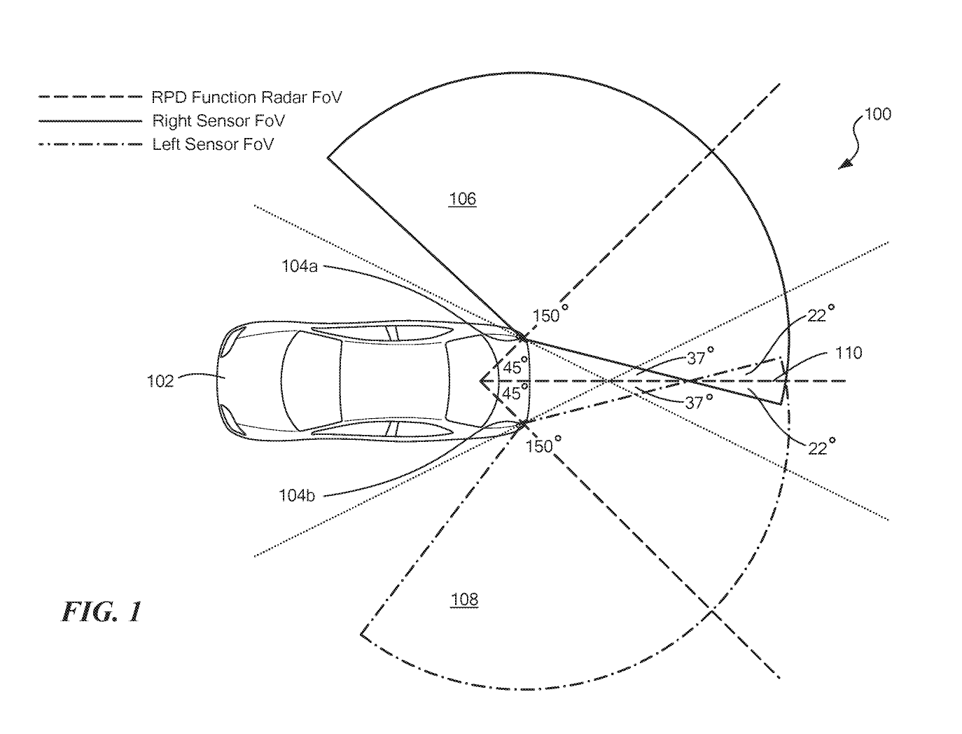

FIG. 1 is a diagram illustrating one example of a vehicle radar sensing scenario 100 within which concepts, structures, and techniques sought to be protected herein may be practiced. As shown, a subject vehicle 102 is equipped within one or more radar sensors (generally denoted 104), with a first sensor 104a and a second sensor 104b shown in the example of FIG. 1.

While a system using two sensors are shown and described, it should be appreciated that the system could be used with only a single sensor. Further, while object/pedestrian detection at a rear of a vehicle is described, it should be appreciated that the same concepts equally apply to detection of an object/pedestrian at a front of a vehicle. Such a sensing system disposed for operation at a front of a vehicle (e.g. in a vehicle moving in a forward direction), may be useful in autonomous driving applications and for object/pedestrian detection at low speed in general.

A first field of view 106 is shown for sensor 104a and a second field of view 108 is shown for sensor 104b. There is an area of overlap 110 for the two fields of view 106 and 108. There is also an area 112 between the fields of view of sensors 104a and 14b. In this particular embodiment, each field of view 106 and 108 have approximately a 150 degree area, with 22 degrees of each field of view overlapping.

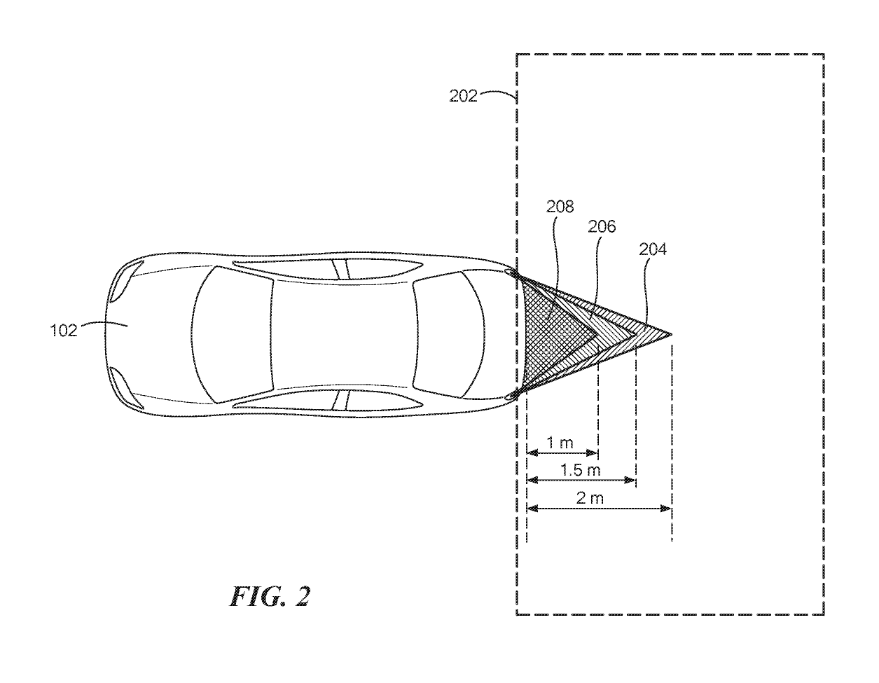

Referring to FIG. 2, an area of coverage behind the vehicle 102 is shown. Area 202 is the full performance expectation area. In a particular embodiment, as the beam rolls off in the region 204, at a distance within two meters, detections are acquired about 50 percent of the time. Area 206 shows that at 1.5 meters, detection performance is degraded to only about 75 percent, and at region 208 within one meter, performance is degraded 100 percent. For detection in region 208, another sensor or different type of sensor (e.g., ultrasonic or vision sensor) may need to be utilized, providing a reduced false alert rate since fused objects need confirmation by both sensor types.

In one particular embodiment, Rear Sensor Fusion may be used. This technique improves image resolution for diffuse scatterers defined as energy scattered over a wide range of angles (humans) and having a diminishing effect at higher range. This technique provides little to no improvement for specular scatterers, defined as energy scattered over a very narrow range of angles (large flat plates).

At least one embodiment, the object/pedestrian detection technique described herein uses what is referred to as Type 1 Integration. Type 1 integration uses a group of range-azimuth histograms produced from detections to create image masks of the area behind the vehicle. The masks provide a two-dimensional (2D) probability distribution within an image map. The masks may be applied to a host-compensated image of the area behind the vehicle to determine a presence of static objects within the image.

The host compensated image, is for determining static objects only. Moving objects are determined from the statistics of the masks themselves. A mask associated with a group having very low spatial uncertainty (high confidence), will get promoted to an object even if little or no energy corresponds to the objects location in the host compensated image. This is because the object is moving. Only static objects will appear “bright” in the host compensated image. Objects that spawn from the host-compensated image can be classified as static versus. groups with very mature statistics but do not have significant image energy are considered non-static. This distinguishable classification will impact the time-to-collision estimation with the host.

In at least one embodiment, the technique may further incorporate Type 2 Integration which involves image processing Synthetic Aperture Radar (SAR) techniques. This improves the signal-to-Noise (SNR) for static targets within the map. Pixels containing detections from static objects will accumulate the fastest, while pixels having detections from dynamic targets appear smeared as energy will be spread out across more adjacent pixels. The type 1 integration assists the type 2 integration by providing spatial weighting to the 2D map.

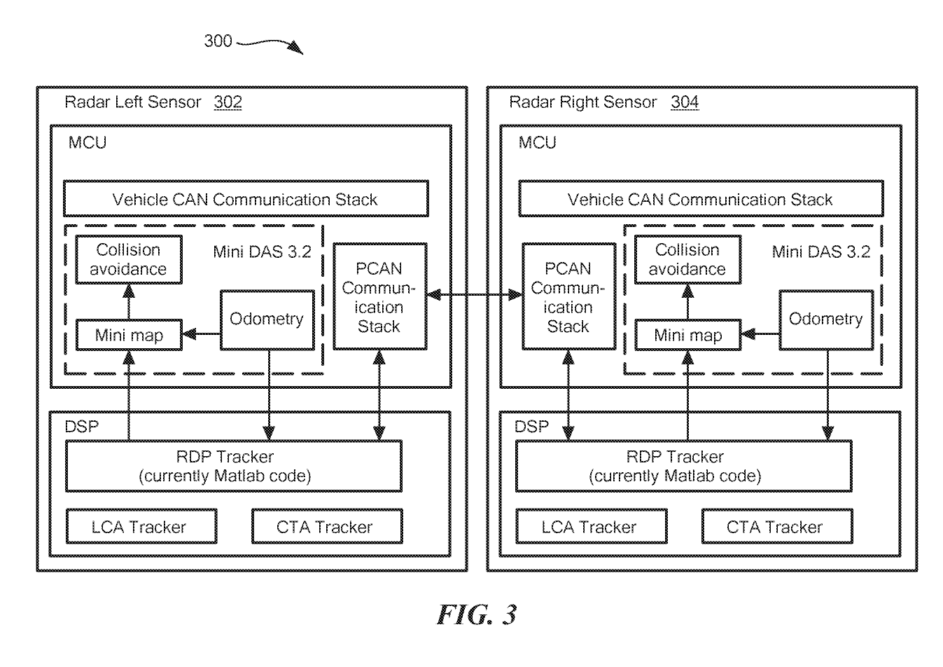

FIG. 3 is a block diagram showing the two sensors environment 300. As shown, a left sensor 302 is in communication with a right sensor 304. The details of the sensor are not explained here, as the concepts sought to be protected herein are directed toward utilizing the data from the sensors. While one embodiment of a sensor is shown, different embodiments of sensors could also be used.

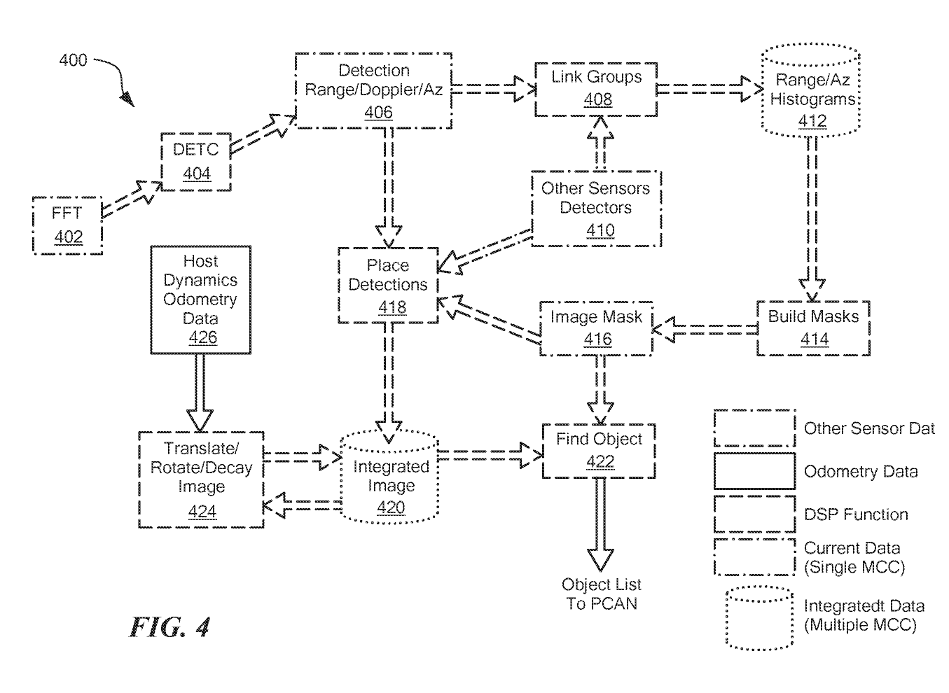

FIG. 4 shows an embodiment of an RPD DSP functional flow diagram 400. A high level over view will be provided with respect to this Figure, with a more detailed explanation and Figures recited below.

Current data is shown in FFT 402, which collects range and doppler information from the one or more sensors. FFT 402 provides this data to DETC 404 which performs detection processing. A local maxima is determined from the 2D Range-Doppler ITT. Thresholds are based on noise estimates in the vicinity of detections.

Block 406 shows data for a detection. The data includes range, doppler and azimuth information for each detection. For each sensor, detections are collected according to range to create a group. For each detection, if the range and Doppler associated with that detection are within a range window and doppler window of an active group, that detection is added to the group, otherwise a new group is provided.

Detections from other sensors, shown in box 410 are also processed. Each sensor gets the data from the other sensor. For example, the left sensor may receive the right sensor data and the right sensor may receive the left sensor. Integration from multiple sensors provides the advantage of observing the scene from multiple aspects.

Box 408 is used for synchronizing the time stamps of detections of one sensor with the detections of the other sensor. This is referred to herein as fusing the detections together. The link groups box 408 combines the data from box 406 with the data from box 410 according to range. Box 408 also performs type 1 integration and feature extraction.

Box 412 utilizes the data from box 408 to take the two linear features of range and azimuth and histogramming them over time. This also results in forming statistics about range uncertainty and azimuth. Histogram masks can be used to weight detections from same sensor.

The current detections are weighted by the integrated statistics of the same sensor. Cross correlation is provided by weighting the current detections from one sensor by the integrated statistics from another sensor, and vice-versa. Associated detections from multiple sensors provides an advantage to diffuse scatterers (e.g., humans), seen at the same physical location by each sensor, and also suppresses sporadic detections, which are rarely observed simultaneously by multiple sensors at the same location. The contribution to the integrated statistics is based on the amount of association (number of associated detections from other sensors).

For the group range and azimuth data histograms, the peak bin represents the maximum likelihood of the group's range and azimuth. The spread of energy across bins represents the uncertainty factor in range and azimuth, which can lead to a confidence metric in two dimensions. The vector direct product (uv) of the two histograms creates a two dimension weighting function, or mask, containing the combined effect of the group's range and azimuth statistics.

In box 414 vector multiplication is performed to create from two one dimensional vectors a two dimensional mask in range and azimuth for that particular group. All the masks for the group are built and in box 416 they are emerged to form an image mask. This box results in an overall mask of a probability distribution of where any given detection would be coming in the future should reside. If this is not the case, then the detection is not for real target.

In box 418 all current detections from the current sensor (box 406) and all detections form other sensors (box 410) are weighted by the image mask (box 416), which provides spatial weighting for every detection before placing detections into an image (box 420). From the integrated image (box 420) the detection of objects can be determined (box 422).

In box 424 the integrated image is propagated over time based on the host dynamic (box 426). The image mask provides the statistical probability for predicting the location of any future detection. Scaling detections by the image mask provides the proper spatial weighting in that detections that are consistent with the integrated statistics of an active group are amplified, while detections that do not coincide with an active group in range and azimuth are suppressed. Host motion compensation requires rotation and translation of the full map referenced to a common system origin.

A weighting factor based on how many detections from the other sensors can be associated with this detection are used. Sensitivity to an object seen simultaneously by multiple sensors at the same range and azimuth is improved while objects such as road irregularities and parked cars are not as correlated as often. This provides an advantage to a human target if co-range with strong reflectors such as parked cars and infrastructure.

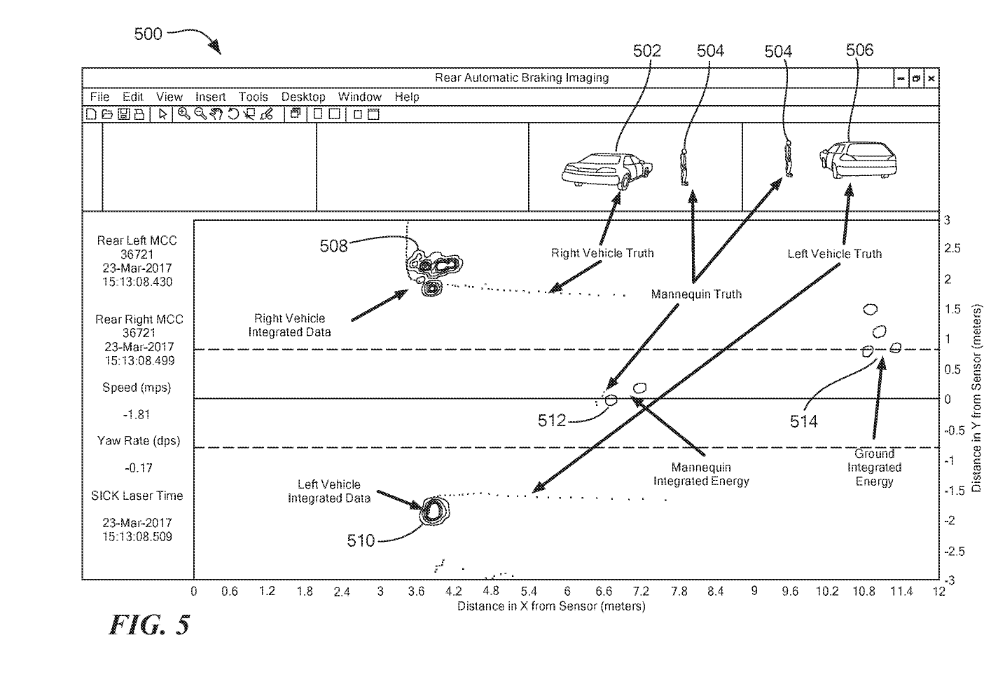

Referring now to FIG. 5, a graph 500 of a RPD scenario is shown. There are two vehicles, a right vehicle 502 and a left vehicle 506. Between the two vehicles is a mannequin 504, representing a person. A vehicle operator may be attempting to back into a space between the two vehicles. The space between the vehicles may have a mannequin there. The right sensor data may show the right vehicle data 508 and the mannequin data 512. The right sensor data may also show ground effects data 514 (e.g., cracks in the pavement or other clutter), the right vehicle data 508, and the mannequin data 512. The left sensor data may show the right vehicle data 508, the left vehicle data 510 and the mannequin data 512. The left sensor data may also show ground effects data 514 (e.g., cracks in the pavement or other clutter).

In this example, the right vehicle data 508 is more pronounced than the left vehicle data 510 since the right sensor detected the right vehicle but not the left vehicle, while the left sensor detected the right vehicle and the left vehicle.

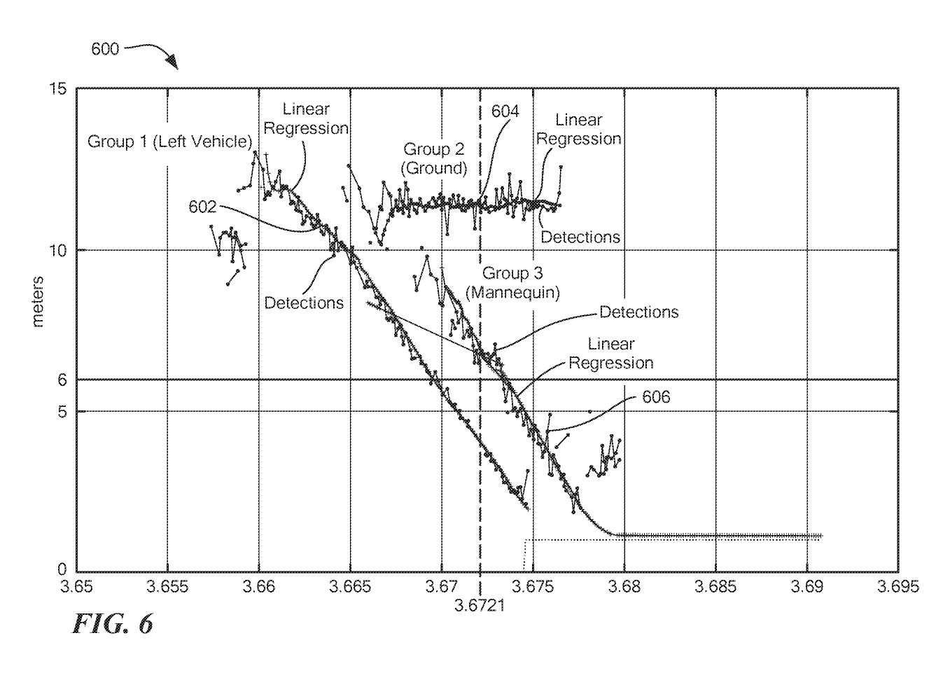

Referring to FIG. 6, a histogram 600 for one vehicle sensor is shown. Three lines are shown. Line 602 shows group 1 (the let vehicle) data. Line 604 shows the group 2 (ground) data. Line 606 shows the group 3 (mannequin) data.

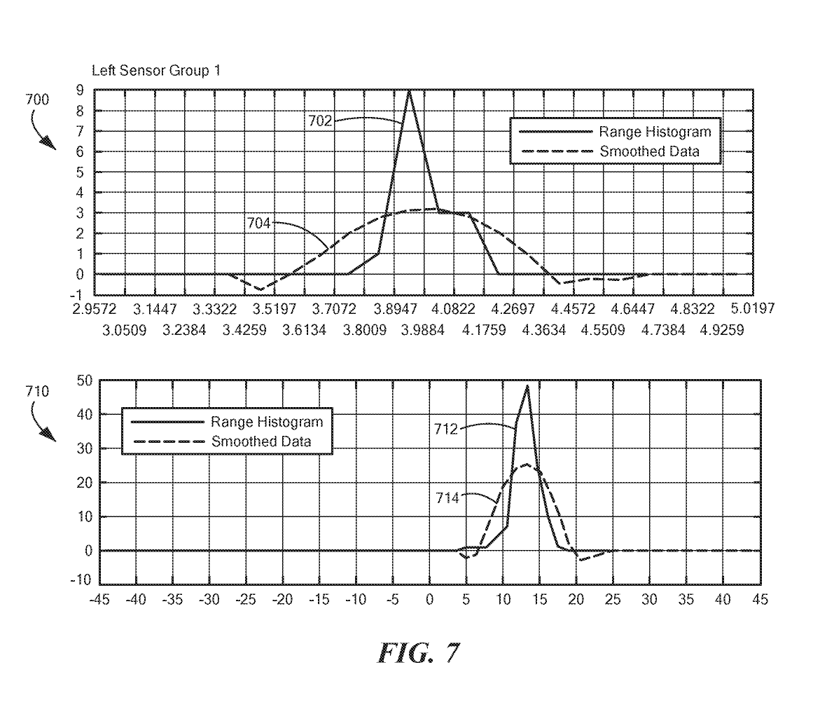

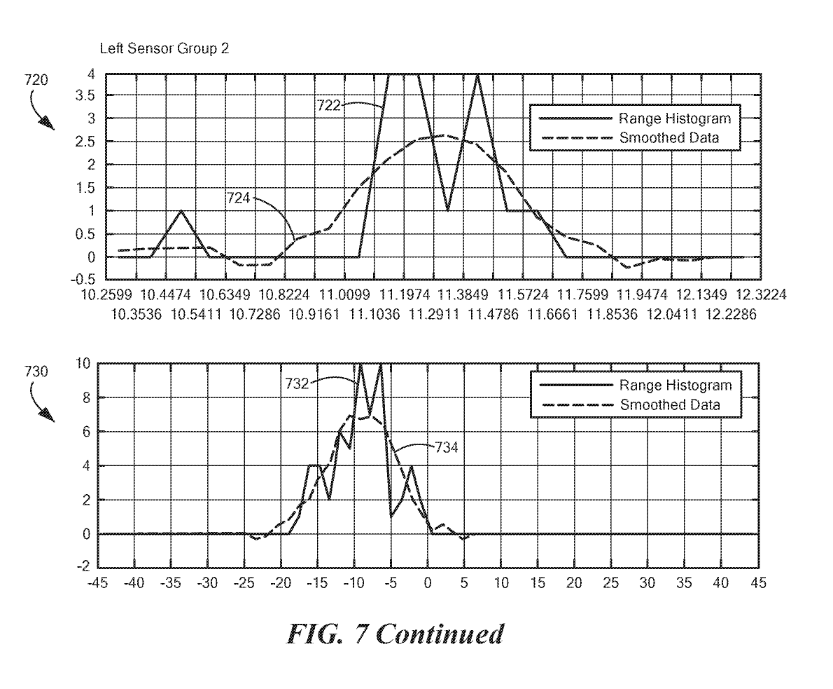

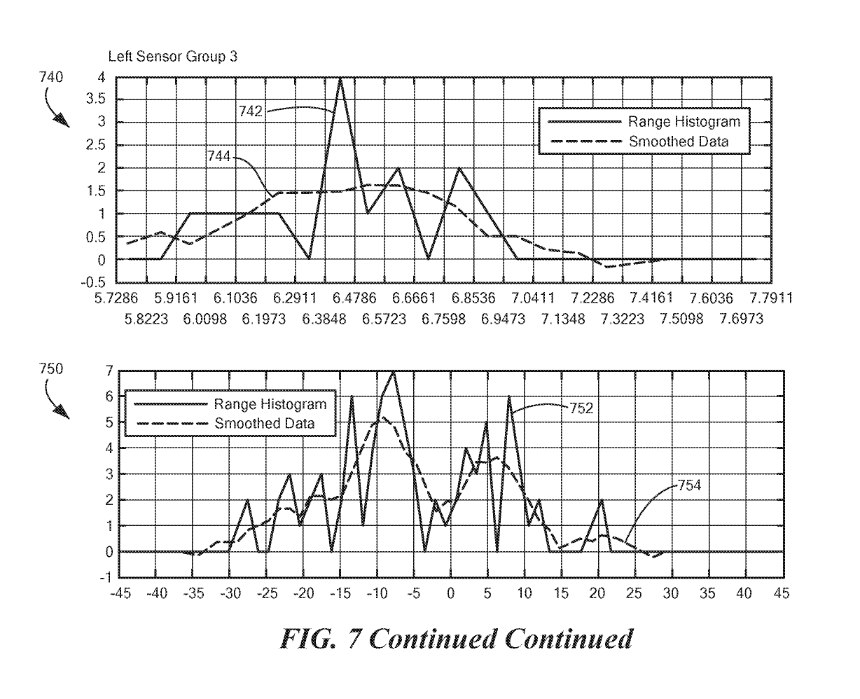

Referring now to FIG. 7, a group of graphs showing range histogram data, azimuth histogram data and the resulting smoothed data for each detected by a sensor is shown. Graph 700 shows the left sensor range data for group 1 (left vehicle). The range histogram 702 shows a peak at about 3.8 meters. The smoothed data 704 shows a curve having a peak at about 3.8 meters. This indicates the presence of a vehicle at that distance from the source vehicle. Graph 710 shows the left sensor azimuth data for group 1 (left vehicle). The azimuth histogram 712 shows a peak at about 12 degrees. The smoothed data 714 shows a curve having a peak at about 12 degrees. This indicates the presence of a vehicle at that angle from the source vehicle.

Graph 720 shows the left sensor range data for group 2 (ground). The range histogram 722 shows a small peak at about 10.5 meters, a larger peak at about 11.2 meters, and another peak at 11.4 meters. The smoothed data 724 shows a curve having a small peak at about 10.5 meters and a larger peak area at about 11.3 meters. This indicates the presence of a ground clutter at that distance from the source vehicle. Graph 730 shows the left sensor azimuth data for group 1 (left vehicle). The azimuth histogram 732 shows a peak at about −11 degrees. The smoothed data 734 shows a curve having a peak at about −10 degrees. This indicates the presence of ground clutter at that angle from the source vehicle.

Graph 740 shows the left sensor range data for group 3 (mannequin). The range histogram 742 shows a plateau from about 6 meters to 6.2 meters, a larger peak at about 6.4 meters, another peak at 6.6 meters and another peak at 6.8 meters. The smoothed data 744 shows a curve having a small peak at about 6.6 meters and extending from 6 meters to 7 meters. This indicates the presence of a mannequin at that distance from the source vehicle. Graph 750 shows the left sensor azimuth data for group 3 (mannequin). The azimuth histogram 752 shows several smaller peaks at −27 degrees, −22 degrees, −17 degrees, −6 degrees, 12 and 20 degrees. Also shown are several larger peaks occurring at −14 degrees, −10 degrees, 0 degrees, 3 degrees and 7 degrees. The smoothed data 754 shows a curve having a larger peak at about −10 degrees and another peak at 5 degrees. This indicates the presence of the mannequin behind the source vehicle.

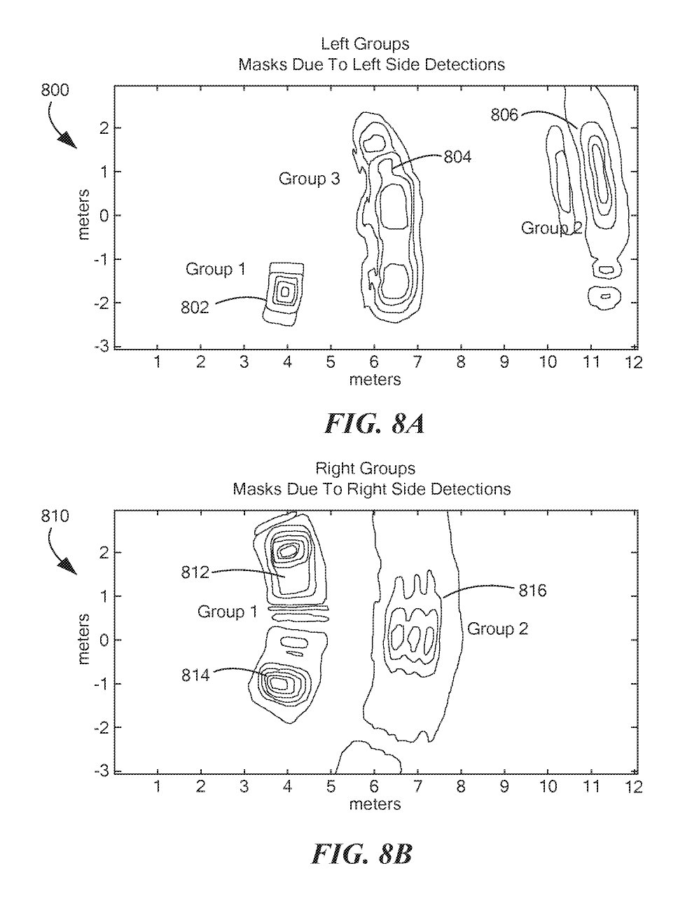

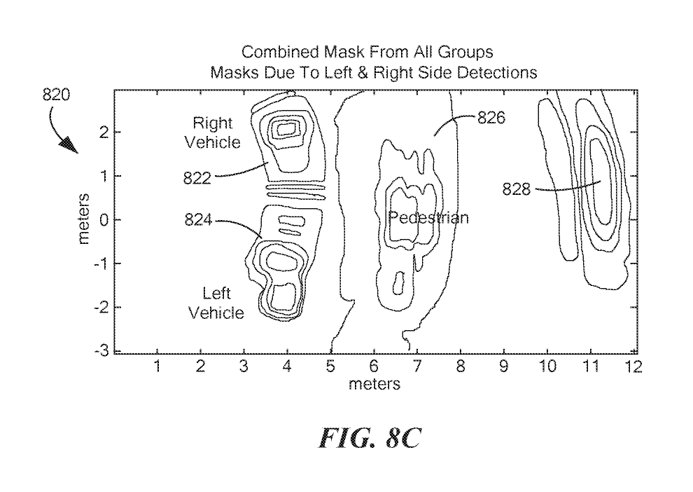

Graph 800 shown in FIG. 8A shows the presence of objects detected by the left vehicle sensor. These group masks have been derived from the histograms of FIG. 7. The group 1 object 802 (parked car) is shown at a distance around 4 meters behind and to the right of the host vehicle. The group 3 object (mannequin) 804 is shown at a distance of about 6.5 meters, and generally directly behind the host vehicle. The group 2 object 806 (ground) is shown at a distance of about 11.5 meters behind the host vehicle.

FIG. 8B shows the presence of objects detected by the right vehicle sensor. These group masks have been derived from the histograms of FIG. 7. The group 1 objects 802 (parked cars) is shown at a distance around 4 meters behind and to the left and to the right of the host vehicle. The group 3 object (mannequin) 816 is shown at a distance of about 6.5 meters, and generally directly behind the host vehicle. There is no group 2 object shown for this sensor.

FIG. 8C is the combined mask from the groups detected by the left and right sensors as shown in FIGS. 8A and 8B. In FIG. 8C, the right vehicle 822 is shown at distance of about 4 meters, as is the left vehicle 824. The mannequin (or pedestrian) 826 is shown at a distance of about 6.5 meters. The ground object 828 is show at a distance of about 11.5 meters.

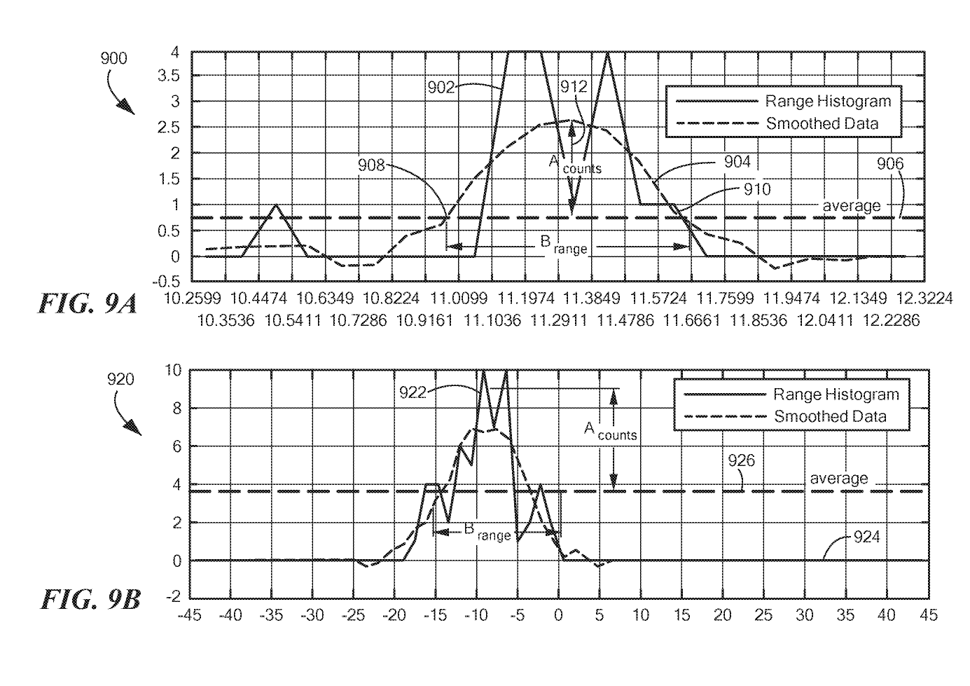

FIGS. 9A and 9B show one example of how a determination of the confidence factor may be derived. In FIG. 9A, the range histogram graph of FIG. 720 is shown. From this graph a range of the curve (Brange) is determined as well Acounts. The range confidence factor is determined by using the smoothed data 904 and the average 906. The value of Brange is determined by calculating the distance between the smoothed data cross over points with the average, points 908 and 910. The Acounts value is determined by taking the distance between the peak 912 and the average 906. The range confidence factor (CF) is calculated by taking the Acounts value and dividing it by the Brange value.

In FIG. 9B, the azimuth histogram graph of FIG. 730 is shown. From this graph a range of the curve (Bdegrees) is determined as well Acounts. The azimuth confidence factor is determined in accordance with the formula:

Brange=(Bdegrees*π/180)*propagated_range

The azimuth CF is then calculated by taking the value of Acounts and dividing it by the value of Brange. The total CF can then be determined by multiplying the range CF by the azimuth CF. The spatial uncertainty is proportional to 1/CF.

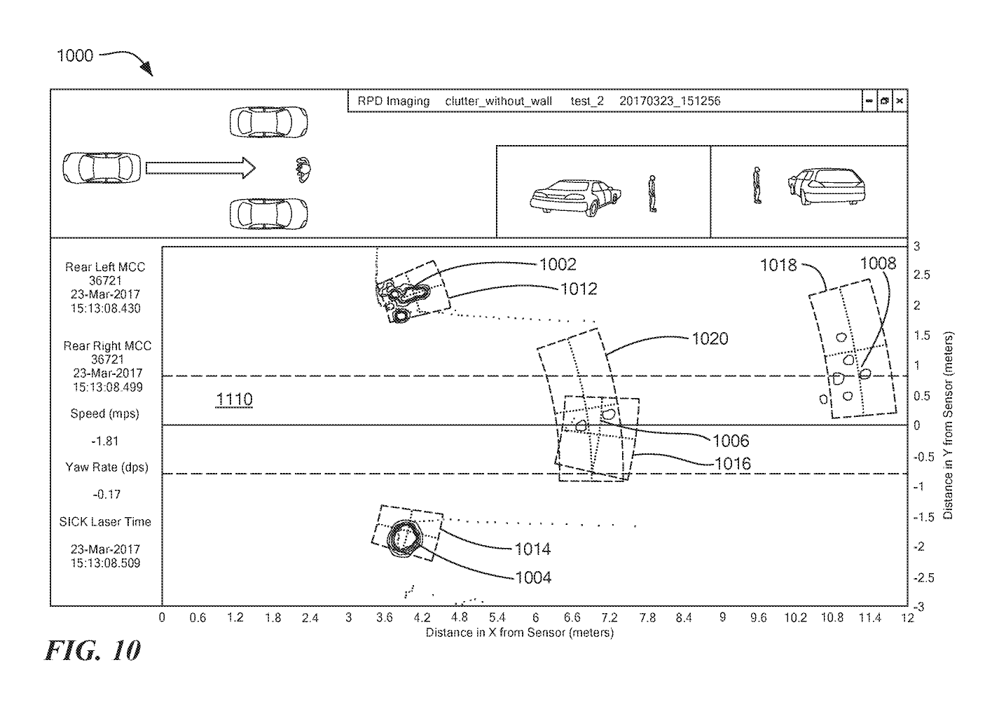

Referring to FIG. 10, a graph showing the group correlation windows and the spatial uncertainty is shown. The presence of the left parked vehicle is shown by object 1002 and the uncertainty box 1012 surrounding object 1002. The smaller the uncertainty box around an object, the more likely the detection is valid. The presence of the right parked vehicle is shown by object 1004 and the uncertainty box 1014 surrounding object 1004. Once again, the smaller the uncertainty box around an object, the more likely the detection is valid.

The presence of the pedestrian/mannequin is shown by object 1006 and the uncertainty boxes 1016 and 1020 surrounding object 1002. Ground object 1008 is shown with uncertainty box 1018.

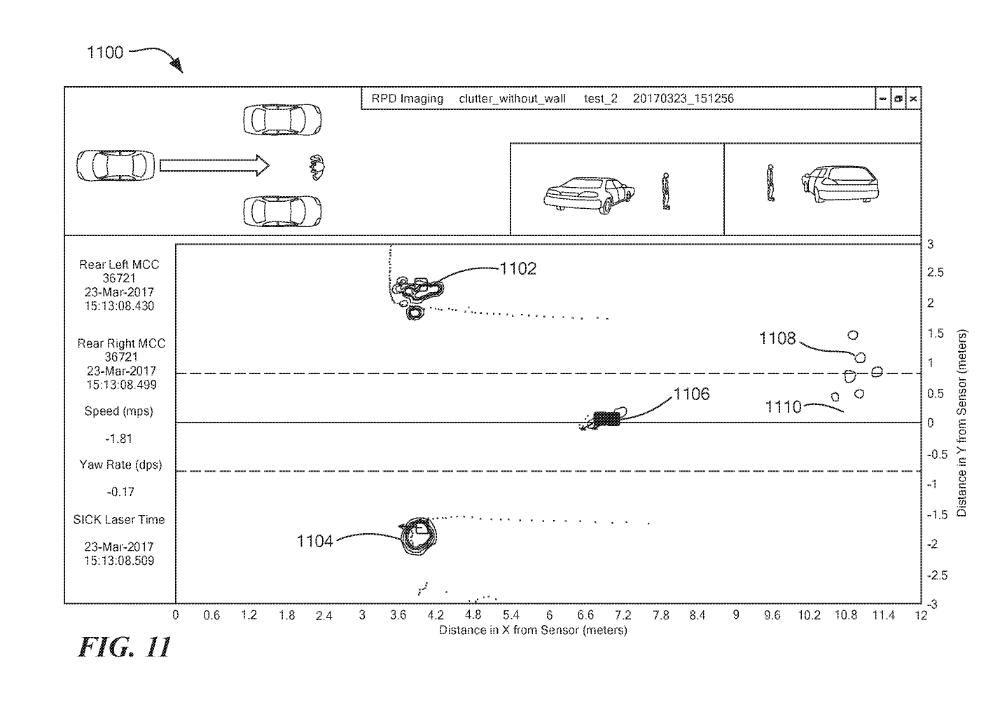

FIG. 11 shows the detected objects without the uncertainty boxes. The mannequin/pedestrian 1106 is shown in the vehicles projected lane 1110 which is between vehicles 1102 and 1104. Pedestrian 1106 is in the middle of the vehicle lane 1110, and a few meters back from the two parked vehicles 1102 and 1104. Ground object 1108 is shown behind the vehicles and the pedestrian.

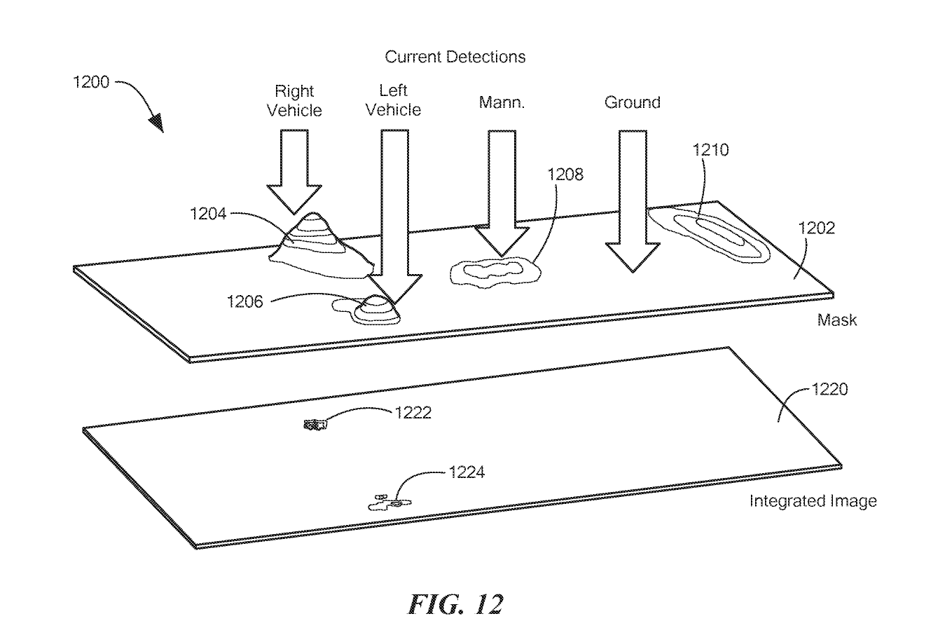

FIG. 12 shows a mask 1202 being used to produce an integrated image 1220. The mask 1202 includes an object 1204 for the right vehicle, an object 1206 for the left vehicle, an object 1208 for the mannequin and an object 1210 for the ground. The right vehicle from the mask is shown as object 1222 on the integrated image and the left vehicle is shown as object 1224 on the integrated image.

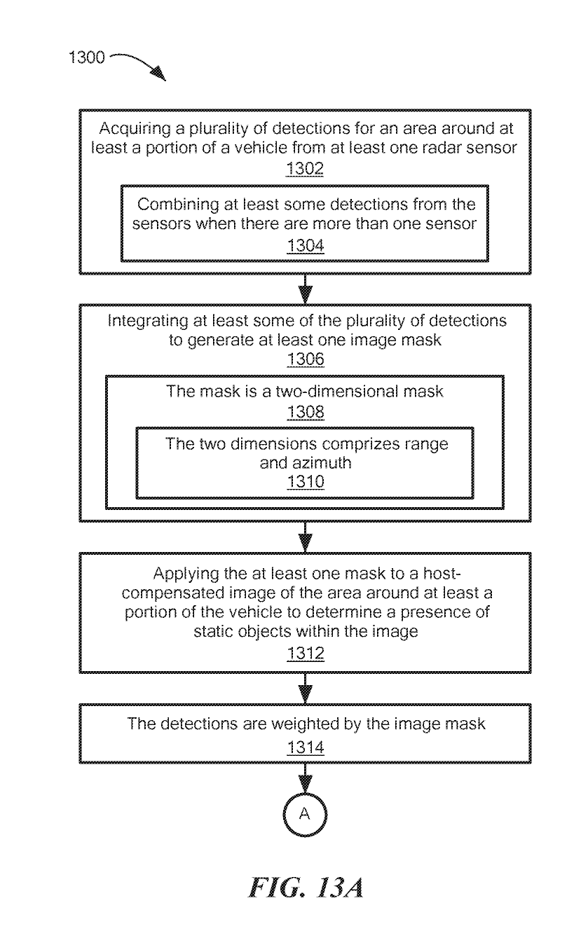

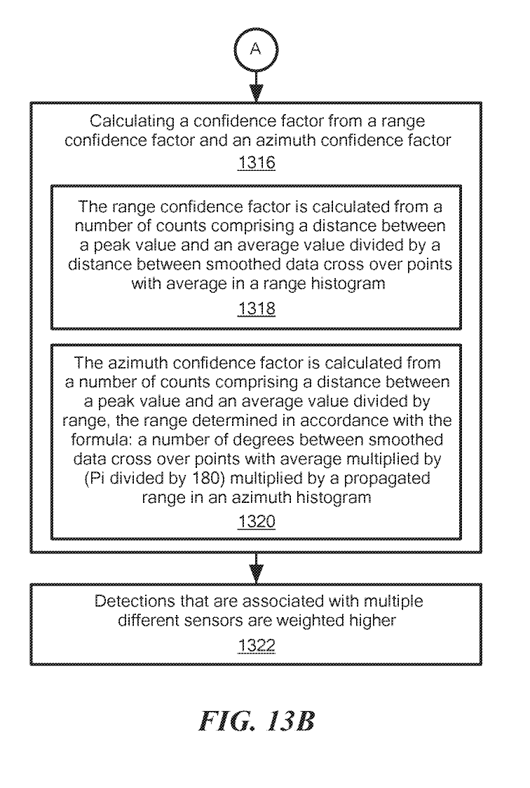

Referring now to FIGS. 13A and 13B, a particular embodiment of a method providing front and/or rear object/pedestrian detection is shown. Rectangular elements, herein denoted “processing blocks,” represent computer software instructions or groups of instructions. Alternatively, the processing blocks may represent steps performed by functionally equivalent circuits such as a digital signal processor (DSP) circuit or an application specific integrated circuit (ASIC). The flow diagrams do not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

Further, the processes and operations described herein can be performed by a computer especially configured for the desired purpose or by a general-purpose computer especially configured for the desired purpose by another computer program stored in a computer readable storage medium or in memory.

Referring to FIGS. 13A and 13B, a particular embodiment of a method 1300 for providing front and/or rear object/pedestrian detection is shown. The method 1300 begins with processing block 1302 which shows acquiring a plurality of detections for an area surrounding at least a portion of a vehicle from at least one radar sensor. As shown in processing block 1304 the step of combining at least some detections from the sensors when there are more than one sensor. This is performed prior to the integrating at least some of the plurality of detections to generate at least one image mask.

Processing block 1306 discloses integrating at least some of the plurality of detections to generate at least one image mask. As shown in processing block 1308, the mask may be a two-dimensional mask. As further shown in processing block 1310 the two dimensions comprises range and azimuth.

Processing block 1312 shows applying the at least one image mask to a host-compensated image of the area surrounding at least a portion of the vehicle to determine a presence of static objects within the image. Processing block 1314 shows the detections are weighted by the image mask.

Processing continues with processing block 1316 which depicts calculating a confidence factor from a range confidence factor and an azimuth confidence factor. As shown in processing block 1318, range confidence factor is calculated from a number of counts comprising a distance between a peak value and an average value divided by a distance between smoothed data cross over points with average in a range histogram. As shown in processing block 1320, the azimuth confidence factor is calculated from a number of counts comprising a distance between a peak value and an average value divided by range, the range determined in accordance with the formula:

a number of degrees between smoothed data cross over points with average multiplied by (Pi divided by 180) multiplied by a propagated range in an azimuth histogram.

Processing block 1322 shows wherein detections that are associated with multiple different sensors are weighted higher.

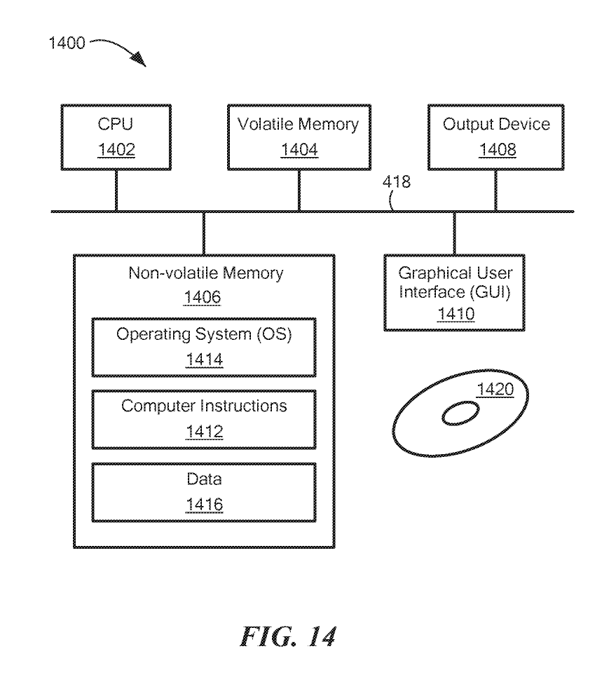

As shown in FIG. 14, computer 1400 may include processor 1402, volatile memory 1404 (e.g., RAM), non-volatile memory 1406 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 1410 (e.g., a touchscreen, a display, and so forth) and input and/or output (I/O) device 1408 (e.g., a mouse, a keyboard, etc.). Non-volatile memory 1406 may also include an Operating System (OS) 1414 and data 1416. In certain embodiments, the computer instructions 1412 are executed by the processor/CPU 1402 out of volatile memory 1404 to perform at least a portion of the processes shown in FIGS. 13A and 13B. Program code also may be applied to data entered using an input device or GUI 1408 or received from I/O device1 420.

The processes of FIGS. 13A and 13B are not limited to use with the hardware and software described and illustrated herein and may find applicability in any computing or processing environment and with any type of machine or set of machines that may be capable of running a computer program. The processes described herein may be implemented in hardware, software, or a combination of the two. The logic for carrying out the method may be embodied as part of the system described in FIG. 14, which is useful for carrying out a method described with reference to embodiments shown in, for example, FIGS. 13A and 13B. The processes described herein are not limited to the specific embodiments described. For example, the processes of FIGS. 13A and 13B are not limited to the specific processing order shown in of FIGS. 13A and 13B. Rather, any of the blocks of the processes may be re-ordered, combined, or removed, performed in parallel or in serial, as necessary, to achieve the results set forth herein.

Processor 1402 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A processor may perform the function, operation, or sequence of operations using digital values or using analog signals. In some embodiments, the processor can be embodied in one or more application specific integrated circuits (ASICs). In some embodiments, the processor may be embodied in one or more microprocessors with associated program memory. In some embodiments, the processor may be embodied in one or more discrete electronic circuits. The processor may be analog, digital, or mixed-signal. In some embodiments, the processor may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the program code is loaded into and executed by a machine, such as the computer of FIG. 4, the machine becomes an apparatus for practicing some or all of the concepts described herein. When implemented on one or more general-purpose processors, the program code combines with such a processor to provide a unique apparatus that operates analogously to specific logic circuits. As such a general-purpose digital machine can be transformed into a special purpose digital machine.

FIG. 14 shows program logic embodied on a computer-readable medium 1420 as shown, and wherein the logic is encoded in computer-executable code configured for carrying out an object detection process in accordance with the concepts describe herein and thereby forming a computer program product. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, the storage medium may be a physical or logical device. In some embodiments, a storage medium may include physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiment, the disclosed embodiments are described as embodied in a specific configuration and using special logical arrangements, but one skilled in the art will appreciate that the device is not limited to the specific configuration but rather only by the claims included with this specification.

Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

We claim:

1. A computer-implemented method comprising:
acquiring a plurality of detections for an area around at least a portion of a vehicle from at least one radar sensor;
integrating at least some of the plurality of detections to generate at least one image mask; and
applying the at least one image mask to a host-compensated image of the area around at least a portion of the vehicle to determine a presence of static objects within the image.

2. The method of claim 1 further comprising, prior to the integrating at least some of the plurality of detections to generate at least one image mask, combining at least some detections from the sensors when there are more than one sensor.

3. The method of claim 1 wherein the mask is a two-dimensional mask.

4. The method of claim 3 wherein the two dimensions comprises range and azimuth.

5. The method of claim 1 wherein the detections are weighted by the image mask.

6. The method of claim 1 further comprising calculating a confidence factor from a range confidence factor and an azimuth confidence factor.

7. The method of claim 6 wherein a range confidence factor is calculated from a number of counts comprising a distance between a peak value and an average value divided by a distance between smoothed data cross over points with average in a range histogram.

8. The method of claim 6 wherein an azimuth confidence factor is calculated from a number of counts comprising a distance between a peak value and an average value divided by range, the range determined in accordance with the formula:
a number of degrees between smoothed data cross over points with average multiplied by (Pi divided by 180) multiplied by a propagated range in an azimuth histogram.

9. The method of claim 1 wherein detections that are associated with multiple different sensors are weighted higher.

10. A system, comprising;
a processor; and
a non-volatile memory in operable communication with the processor and storing computer program code that when executed on the processor causes the processor to execute a process operable to perform the operations of:
acquiring a plurality of detections for an area around at least a portion of a vehicle from at least one radar sensor;
integrating at least some of the plurality of detections to generate at least one image mask; and
applying the at least one mask to a host-compensated image of the area around at least a portion of the vehicle to determine a presence of all static objects within the image.

11. The system of claim 10 further comprising, prior to the integrating at least some of the plurality of detections to generate at least one image mask, combining at least some detections from the sensors when there are more than one sensor.

12. The system of claim 10 wherein the mask is a two-dimensional mask.

13. The system of claim 12 wherein the two dimensions comprises range and azimuth.

14. The system of claim 10 wherein the detections are weighted by the image mask.

15. The system of claim 10 further comprising calculating a confidence factor from a range confidence factor and an azimuth confidence factor.

16. The system of claim 15 wherein a range confidence factor is calculated from a number of counts comprising a distance between a peak value and an average value divided by a distance between smoothed data cross over points with average in a range histogram.

17. The system of claim 15 wherein an azimuth confidence factor is calculated from a number of counts comprising a distance between a peak value and an average value divided by range, the range determined in accordance with the formula:
a number of degrees between smoothed data cross over points with average multiplied by (Pi divided by 180) multiplied by a propagated range in an azimuth histogram.

18. The system of claim 10 wherein detections that are associated with multiple different sensors are weighted higher.

19. A computer program product including a non-transitory computer readable storage medium having computer program code encoded thereon that when executed on a processor of a computer causes the computer to operate a system, the computer program product comprising:
computer program code for acquiring a plurality of detections for an area around at least a portion of a vehicle from at least one radar sensor;
computer program code for integrating at least some of the plurality of detections to generate at least one image mask; and
computer program code for applying the at least one mask to a host-compensated image of the area around at least a portion of the vehicle to determine a presence of objects within the image.

20. The computer program product of claim 19 further comprising, prior to the integrating at least some of the plurality of detections to generate at least one image mask, combining at least some detections from the sensors when there are more than one sensor.

21. The computer program product of claim 19 wherein the mask is a two-dimensional mask.

22. The computer program product of claim 21 wherein the two dimensions comprises range and azimuth.

23. The computer program product of claim 19 wherein the detections are weighted by the image mask.

24. The computer program product of claim 19 further comprising calculating a confidence factor from a range confidence factor and an azimuth confidence factor.

25. The computer program product of claim 24 wherein a range confidence factor is calculated from a number of counts comprising a distance between a peak value and an average value divided by a distance between smoothed data cross over points with average in a range histogram.

26. The computer program product of claim 24 wherein an azimuth confidence factor is calculated from a number of counts comprising a distance between a peak value and an average value divided by range, the range determined in accordance with the formula:
a number of degrees between smoothed data cross over points with average multiplied by (Pi divided by 180) multiplied by a propagated range in an azimuth histogram.

27. The computer program product of claim 19 wherein detections that are associated with multiple different sensors are weighted higher.
